(19) United States
(12) Patent Application Publication
(10) Pub. No.: US 2026/0348433 A1
(43) Pub. Date: Nov. 5, 2026

(54) VEHICLE WHEEL BEARING

(71) Applicant: ILJIN GLOBAL CO., LTD., Seoul (KR)

(72) Inventors: Jin Hyeok LEE, Seoul (KR); Soo Ha BACK, Seoul (KR)

(73) Assignee: ILJIN GLOBAL CO., LTD., Seoul (KR)

(21) Appl. No.: 19/485,805

(22) PCT Filed: May 20, 2024
(86) PCT No.: PCT/KR2024/006816

§ 371 Date: Nov. 19, 2025

(30) Foreign Application Priority Data
May 19, 2023 (KR) 10-2023-0065303

(51) Int. Cl. F16C 33/78; F16C 19/18; F16C 19/38

(52) U.S. Cl. CPC F16C 33/7823; F16C 19/184; F16C 19/386; F16C 2326/02

(57) ABSTRACT

A vehicle wheel bearing includes a wheel hub; at least one inner ring; an outer ring fixedly coupled to a vehicle-body-side member; a plurality of rolling elements configured to rotatably support the wheel hub and the inner rings; and a sealing member configured to prevent inflow of foreign substances. An axially inner end surface of the wheel hub or the inner ring is provided with a face spline portion, and the face spline portion is configured to engage with corresponding face spline portion formed on a constant velocity joint to transmit driving power. The sealing member includes an outboard-side sealing member configured to perform sealing at an axially outer end portion of a bearing space; an inboard-side sealing member configured to perform sealing at an axially inner end portion of the bearing space; and a spline portion sealing member configured to perform sealing around the face spline portion.

### TECHNICAL FIELD

The present disclosure relates to a vehicle wheel bearing for rotatably mounting and supporting a vehicle wheel to a vehicle body, and more particularly, to a vehicle wheel bearing configured to transmit driving power through face-splines formed on an axial end surface.

### DESCRIPTION OF THE RELATED ART

A wheel bearing is a device for rotatably mounting and supporting a vehicle wheel to a vehicle body, and may be classified into a drive-wheel wheel bearing used for a drive wheel of a vehicle and a driven-wheel wheel bearing used for a driven wheel of the vehicle.

Referring to FIG. 1, a structure of a conventional drive-wheel wheel bearing is illustratively shown.

As shown in FIG. 1, a wheel bearing 10 is configured such that a rotating element (for example, a wheel hub 20 and an inner ring 30) to which a wheel is mounted is connected to a non-rotating element (for example, an outer ring 40) fixed to a vehicle body through rolling elements 50, thereby rotatably supporting the vehicle wheel with respect to the vehicle body. A constant velocity joint 60 is coupled to one side of the wheel bearing 10 so as to transmit driving power generated by a drive device to the wheel bearing 10.

Meanwhile, the constant velocity joint 60 may be formed in a structure in which rolling members 80 (for example, ball members) and an inner member supporting the rolling members are accommodated in an outer member 70, and a central shaft 90 connected to the drive device is coupled to the inner member. A stem portion 75 extending in an axial direction is formed at an axially outer end of the outer member 70, and splines formed on an outer circumferential surface of the stem portion 75 are configured to be engaged with splines formed on an inner circumferential surface of the wheel hub 20.

However, since the wheel bearing 10 having such a structure is configured to transmit driving power by engaging axial splines formed on the stem portion 75 of the constant velocity joint 60 with axial splines formed on the wheel hub 20, it is necessary to form the stem portion 75 having a relatively long length extending through the wheel hub 20. As a result, the weight of the wheel bearing assembly increases, and noise or vibration may occur during acceleration and deceleration.

As a measure to address these problems, in the field of vehicle wheel bearings, vehicle wheel bearings have been proposed in which face-splines are formed on axial end surfaces of a rotating element (for example, a wheel hub, an inner ring, or the like) of the wheel bearing and a constant velocity joint, and driving power is transmitted through engagement of the face-splines.

### DISCLOSURE OF THE INVENTION

### Technical Goals

The present disclosure is for the purpose of providing a vehicle wheel bearing configured to transmit driving power through face-splines formed on axial end surfaces of a wheel bearing and a constant velocity joint, in which a sealing member disposed in the vicinity of the face-splines and a mounting structure thereof are improved so as to enhance assemblability and sealing performance

### Technical Solutions

Representative configurations of the present disclosure to achieve the above-described purpose are as follows.

According to an embodiment of the present disclosure, a vehicle wheel bearing for rotatably mounting and supporting a vehicle wheel to a vehicle body may be provided. The vehicle wheel bearing according to an embodiment of the present disclosure may comprise: a wheel hub to which a vehicle wheel is mounted and which rotates together with the vehicle wheel; at least one inner ring mounted to the wheel hub; an outer ring fixedly coupled to a vehicle-body-side member; a plurality of rolling elements configured to rotatably support the wheel hub and the inner rings relative to the outer ring; and a sealing member configured to prevent inflow of foreign substances. According to an embodiment of the present disclosure, an axially inner end surface of the wheel hub or the inner ring may be provided with a face spline portion, and the face spline portion may be configured to engage with corresponding face spline portion formed on a constant velocity joint to transmit driving power. According to an embodiment of the present disclosure, the sealing member may comprise: an outboard-side sealing member configured to perform sealing at an axially outer end portion of a bearing space in which the rolling elements are located; an inboard-side sealing member configured to perform sealing at an axially inner end portion of the bearing space; and a spline portion sealing member configured to perform sealing around the face spline portion. According to an embodiment of the present disclosure, the spline portion sealing member may be configured to be mounted to an outer circumferential surface of the inner ring in a press-fitted manner, and a stopper portion may be provided on the outer circumferential surface of the inner ring so that movement of the spline portion sealing member is prevented by the stopper portion.

According to an embodiment of the present disclosure, the inboard-side sealing member may be configured to be mounted to the spline portion sealing member in a press-fitted manner.

According to an embodiment of the present disclosure, an axially inner end portion of the inner ring may comprise an extension portion extending axially inward, and an outer circumferential surface of the extension portion may be provided with an inclined portion having a diameter that decreases as it extends axially inward.

According to an embodiment of the present disclosure, the spline portion sealing member may be disposed to be spaced apart from the inclined portion.

According to an embodiment of the present disclosure, the inclined portion may be formed as an inclined surface having an inclination angle of 30° or less with respect to an axial direction.

According to an embodiment of the present disclosure, the spline portion sealing member may comprise a frame and an elastic sealing portion attached to the frame, and the spline portion sealing member may be configured such that the frame is mounted to the outer circumferential surface of the inner ring in a press-fitted manner.

According to an embodiment of the present disclosure, the frame of the spline portion sealing member may comprise: a press-fitting portion on which the inboard-side sealing member is mounted; and a diameter-reduced portion positioned axially inward of the press-fitting portion.

According to an embodiment of the present disclosure, the elastic sealing portion of the spline portion sealing member may be formed to the diameter-reduced portion of the frame, and an outer circumferential surface of the elastic sealing portion of the spline portion sealing member may be formed to have a diameter smaller than an outer circumferential surface of the press-fitting portion of the frame.

According to an embodiment of the present disclosure, the frame of the spline portion sealing member may comprise a bent portion bent in a radial direction at an axially outer end portion thereof.

According to an embodiment of the present disclosure, the elastic sealing portion of the spline portion sealing member may comprise at least one sealing lip, and the sealing lip may be configured to contact a portion of the constant velocity joint to perform sealing. According to an embodiment of the present disclosure, the stopper portion may be formed as a protrusion or a stepped shape protruding radially outward from the outer circumferential surface of the inner ring, such that one side of the spline portion sealing member is caught by the protrusion or stepped-shaped stopper portion to prevent movement thereof.

According to an embodiment of the present disclosure, a radially outer end of an axial contact end surface of the stopper portion that contacts the spline portion sealing member may be positioned radially outward relative to an outer circumferential surface of the press-fitting portion of the frame of the spline portion sealing member.

According to an embodiment of the present disclosure, an axial length from an axially outer end of the inclined portion to the axial contact end surface of the stopper portion may be formed to be greater than an axial length from the axial contact end surface of the stopper portion to an axially inner end of axially inner rolling elements.

According to an embodiment of the present disclosure, the stopper portion may be formed as a recessed structure recessed radially inward from the outer circumferential surface of the inner ring, such that one side of the spline portion sealing member is caught by the recessed stopper portion to prevent movement thereof.

According to an embodiment of the present disclosure, an axial length from an axially outer end of the inclined portion to a center of the recessed stopper portion may be formed to be smaller than an axial length from the center of the recessed stopper portion to an axially inner end of axially inner rolling elements.

In addition, the vehicle wheel bearing according to the present disclosure may further comprise other additional components to the extent that it does not impair the technical idea of the present disclosure.

### Effects

According to an embodiment of the present disclosure, the vehicle wheel bearing is configured to transmit driving power through engagement of face spline portions, thereby enabling simplification of the wheel bearing structure and reduction in weight as compared with conventional vehicle wheel bearings that transmit driving power through axial spline engagement.

In addition, according to an embodiment of the present disclosure, the vehicle wheel bearing is configured such that an inboard-side sealing member is press-fitted and mounted to a spline portion sealing member that seals the face spline portions. Accordingly, both the inboard-side sealing member and the spline portion sealing member can be easily mounted on an inner ring without providing a plurality of separate mounting portions on the inner ring.

Further, according to an embodiment of the present disclosure, the vehicle wheel bearing is configured such that a stopper portion is provided on an outer circumferential surface of the inner ring to which the spline portion sealing member is press-fitted. As a result, it is possible to prevent a problem in which the spline portion sealing member is pushed and displaced by press-fitting force when the spline portion sealing member is press-fitted to the inner ring and/or when the inboard-side sealing member is press-fitted to the spline portion sealing member.

### BRIEF DESCRIPTION OF THE DRAWINGS

FIG. 1 illustratively shows a structure of a conventional vehicle wheel bearing (a drive-shaft wheel bearing).

FIGS. 2 and 3 illustratively shows a structure of a vehicle wheel bearing according to an embodiment of the present disclosure. [FIG. 2 shows a state in which a constant velocity joint is coupled to the wheel bearing, and FIG. 3 shows a state in which the constant velocity joint is omitted.]

FIGS. 4 and 5 illustratively shows a cross-sectional structures of a vehicle wheel bearing according to an embodiment of the present disclosure. [FIG. 4 shows a state in which a constant velocity joint is coupled to the wheel bearing, and FIG. 5 shows a state in which the constant velocity joint is omitted.]

FIG. 6 illustratively shows a structure of an inner ring that may be used in a vehicle wheel bearing according to an embodiment of the present disclosure.

FIG. 7 illustratively shows a structure of a spline portion sealing member that may be used in a vehicle wheel bearing according to an embodiment of the present disclosure.

FIG. 8 illustratively shows a structure of a portion, to which an inboard-side sealing member and the spline portion sealing member are mounted, in the vehicle wheel bearing shown in FIGS. 2 to 5.

FIGS. 9 and 10 illustratively show modified examples of a stopper portion for preventing displacement of the spline portion sealing member.

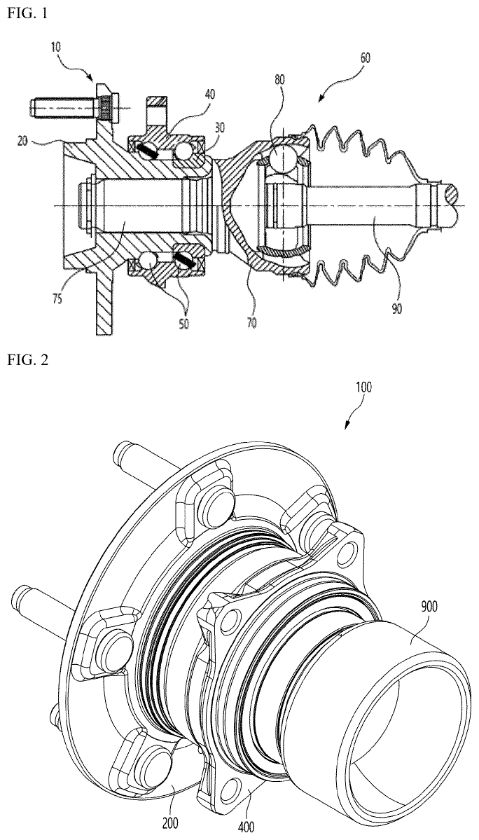

### EXPLANATION OF REFERENCE NUMERALS

100: vehicle wheel bearing
200: wheel hub
210: wheel mounting flange
220: inner ring mounting portion
230: forming portion
240: spline coupling portion
250: press-fit mounting portion
300: inner ring
310: face spline portion
320: recess
330: axial spline portion
340: cylindrical press-fit portion
350: outer circumferential surface of inner ring
360: extension portion of inner ring
370: stopper portion
400: outer ring
410: vehicle-body-side mounting flange
500: rolling elements
600: outboard-side sealing member
700: inboard-side sealing member
800: spline portion sealing member
810: frame of spline portion sealing member
820: elastic sealing portion of spline portion sealing member
900: constant velocity joint
910: corresponding face spline portion of constant velocity joint

### DETAILED DESCRIPTION

Example embodiments of the present disclosure described herein are exemplified for the purpose of describing the technical spirit of the present disclosure. The scope of the claims according to the present disclosure is not limited to the example embodiments described below or to detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising,” “including,” “having,” and the like used herein should be construed as open-ended terms encompassing the possibility of including other example embodiments.

The term “axial direction” used herein may be defined as a direction extending along a rotational central axis of a wheel bearing, wherein “axially inner” refers to a direction toward a vehicle body, and “axially outer” refers to a direction toward a wheel. The term “radial direction” used herein may be defined as a direction perpendicular to the axial direction and away from the rotational central axis or approaching the rotational central axis. The term “circumferential direction” used herein may be defined as a direction rotating about the axial direction described above.

Unless the phrase or sentence clearly indicates otherwise, the expression “a constituent element extends in the axial direction or the radial direction” used herein should be understood as encompassing a case where the constituent element extends parallel to the axial direction or the radial direction as well as a case where the constituent element extends obliquely with respect to the axial direction or the radial direction.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, preferred embodiments of the present disclosure will be described in detail with reference to the accompanying drawings to such an extent that a person having ordinary skill in the art to which the present disclosure pertains can readily practice the present disclosure. In the accompanying drawings, the same reference numerals are assigned to the same or corresponding components. Furthermore, in the following descriptions of the example embodiments, duplicate description(s) of the same or corresponding constituent elements may be omitted. However, even if description(s) of a specific component is omitted in the following description, this is not intended to mean that such component is excluded from the corresponding embodiment.

Referring to the drawings, a vehicle wheel bearing 100 according to an embodiment of the present disclosure is illustratively shown. As shown in the drawings, the vehicle wheel bearing 100 according to the embodiment of the present disclosure may be formed to have an overall structure substantially similar to that of a conventional vehicle wheel bearing.

According to an embodiment of the present disclosure, the vehicle wheel bearing 100 may comprise: a wheel hub 200 on which a vehicle wheel is mounted and which rotates together with the vehicle wheel; at least one inner ring 300 mounted on the wheel hub 200; an outer ring 400 fixedly coupled to a vehicle-body-side member; and a plurality of rolling elements 500 configured to rotatably support the wheel hub 200 and the inner ring 300 relative to the outer ring 400.

According to an embodiment of the present disclosure, the wheel hub 200 may be formed in a substantially cylindrical shape extending in an axial direction, and a wheel mounting flange 210 (hub flange) may be provided on an outer circumferential surface of the wheel hub 200. The wheel mounting flange 210 may extend radially outward from the outer circumferential surface of the wheel hub 200 and may be used to mount the vehicle wheel to the wheel hub 200 by means of hub bolts or the like. Meanwhile, the inner ring 300 may be press-fitted and mounted on a vehicle-body-side end of the wheel hub 200, and a raceway (inner raceway) for the rolling elements may be formed on a portion of the outer circumferential surface of the wheel hub 200 to support the rolling elements 500 from a radially inner side.

According to an embodiment of the present disclosure, at least one inner ring 300 may be mounted on the outer circumferential surface of the wheel hub 200, and a raceway (inner raceway) for the rolling elements may be formed on an outer circumferential surface of the inner ring 300 to support the rolling elements 500 from a radially inner side. For example, the inner ring 300 may be coupled to a mounting portion 220 provided near the vehicle-body-side end of the wheel hub 200 and may be fixed to the wheel hub 200 in a state in which a predetermined preload is applied.

According to an embodiment of the present disclosure, the outer ring 400 may comprise, on an outer circumferential surface thereof, a vehicle-body-side mounting flange 410 used to mount the wheel bearing 100 to a vehicle-body-side member, and may comprise, on an inner circumferential surface thereof, raceways (outer raceways) with which the rolling elements 500 are in contact. The outer raceways formed on the inner circumferential surface of the outer ring 400 may cooperate with the inner raceways formed on the wheel hub 200 and/or the inner ring 300 to receive and support the rolling elements 500, which serve as rolling members, between the raceways.

According to an embodiment of the present disclosure, the rolling elements 500 may be disposed between a rotating element of the wheel bearing 100 (for example, the wheel hub 200 and/or the inner ring 300) and a non-rotating element (the outer ring 400) of the wheel bearing 100, and may perform a function of rotatably supporting the rotating element of the wheel bearing 100 relative to the non-rotating element of the wheel bearing 100.

However, the above-described configurations of the vehicular wheel bearing 100 according to an embodiment of the present disclosure are not necessarily limited to the structures shown in the drawings, and may be variously modified into different structures applicable to vehicular wheel bearings.

For example, in the embodiment shown in the drawings, the vehicular wheel bearing 100 is configured such that one raceway for supporting the rolling elements 500 is directly formed on an outer circumferential surface of the wheel hub 200. However, the vehicular wheel bearing 100 according to an embodiment of the present disclosure may be implemented in other modified structures, such as a structure in which two inner rings 300 are mounted on the wheel hub 200 and the rolling elements 500 are supported by the two inner rings 300.

Further, in the embodiment shown in the drawings, the rolling elements 500 configured to rotatably support the rotating element (for example, the wheel hub 200 and/or the inner ring 300) of the wheel bearing 100 relative to the non-rotating element (for example, the outer ring 400) of the wheel bearing 100 are formed in a spherical balls. However, the rolling elements 500 may alternatively be formed in other shapes of rolling members, such as taper rollers.

Meanwhile, according to an embodiment of the present disclosure, a rotating element (for example, the wheel hub 200 or the inner ring 300) of the wheel bearing may be provided with a face spline portion 310 on an axial end surface thereof, such that the face spline portion 310 is engaged with corresponding face spline portion 910 formed on a constant velocity joint 900 to transmit driving power.

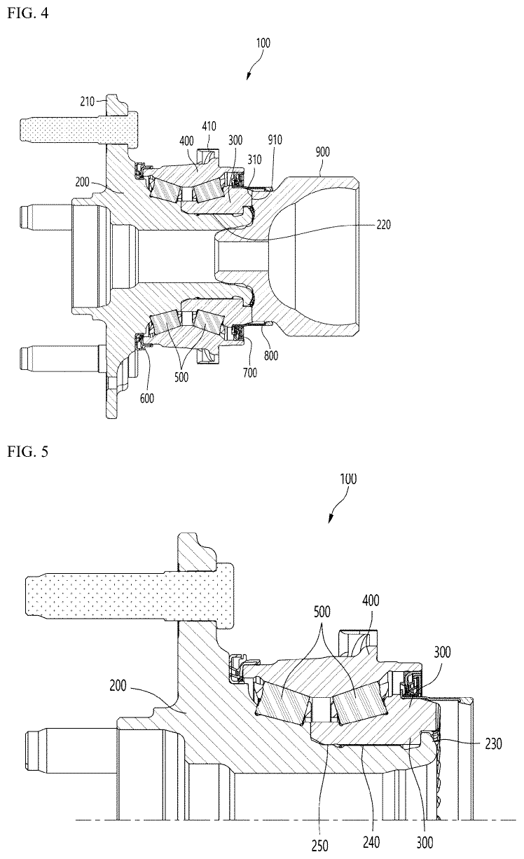

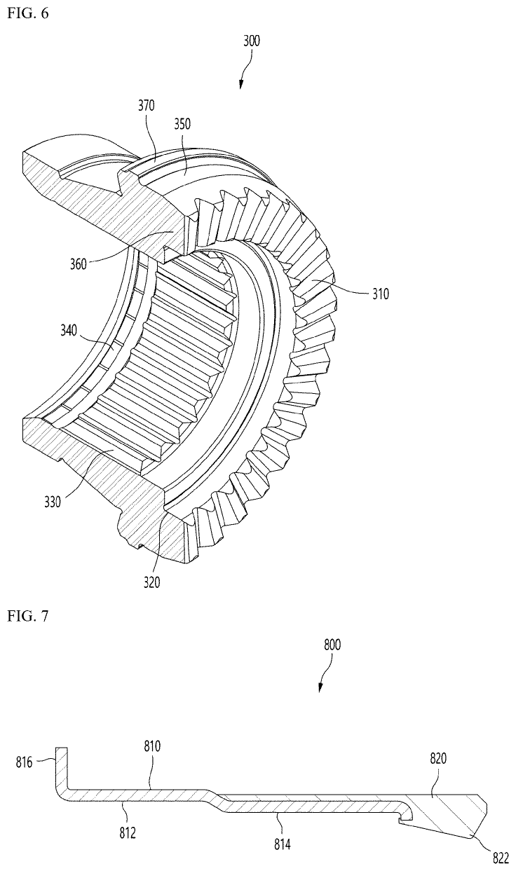

For example, according to an embodiment of the present disclosure, the vehicular wheel bearing 100 may be configured such that the face spline portion 310 is formed on an inner axial end face of the inner ring 300, and the face spline portion 310 is engaged with the corresponding face spline portion 910 formed on an outer axial end face of the constant velocity joint 900 (see FIGS. 4 to 6).

However, in the vehicular wheel bearing 100 according to an embodiment of the present disclosure, the face spline portion 310 is not necessarily formed on the inner ring 300 as shown in the drawings, and may alternatively be formed on an inner axial end face of the wheel hub 200.

According to an embodiment of the present disclosure, the face spline portion 310 of the wheel bearing 100 and the corresponding face spline portion 910 of the constant velocity joint 900 are preferably formed such that a pressure angle of the teeth is 55° or greater.

According to an embodiment of the present disclosure, a recess 320 is provided on an inner circumferential surface of an axially inner end portion of the inner ring 300, such that a forming portion 230 of the wheel hub 200 for fixing the inner ring 300 is formed and received in the recess 320.

As such, the vehicular wheel bearing according to an embodiment of the present disclosure is configured to transmit driving power through spline-engagement of the face spline portions formed on axial end faces of the wheel bearing and the constant velocity joint. Accordingly, it is not necessary to form a stem portion, which extends to a long length in the axial direction, to the constant velocity joint to establish an axial spline coupling, thereby reducing the weight of the wheel bearing assembly and suppressing the generation of noise during operation of the wheel bearing.

According to an embodiment of the present disclosure, an axial spline portion 330 may be provided on the inner circumferential surface of the inner ring 300, and the axial spline portion 330 may be configured to be engaged with a spline coupling portion 240 provided on an outer circumferential surface of the wheel hub 200 (specifically, an outer circumferential surface of an inner-ring mounting portion 220 of the wheel hub 200). For example, the axial spline portion 330 formed on the inner circumferential surface of the inner ring 300 may be configured to be spline-press-fitted to the spline coupling portion 240 provided on the wheel hub 200.

According to an embodiment of the present disclosure, a cylindrical press-fit portion 340 may be provided on an inner circumferential surface of the inner ring 300 at an axially outer position relative to the above-described axial spline portion 330. The cylindrical press-fit portion 340 may be configured to be press-fitted and coupled to a press-fit mounting portion 250 provided on an outer circumferential surface of the wheel hub 200 (specifically, an outer circumferential surface of an inner-ring mounting portion 220 of the wheel hub 200).

As such, the vehicular wheel bearing 100 according to an embodiment of the present disclosure is configured to mount the inner ring 300 to the wheel hub 200 by using both the cylindrical press-fit portion and the axial spline portion. Accordingly, the inner ring 300 can be securely mounted and fixed on the wheel hub 200, and driving power can be stably transmitted to the wheel hub 200 on which a vehicle wheel is mounted.

According to an embodiment of the present disclosure, the cylindrical press-fit portion 340 provided on the inner circumferential surface of the inner ring 300 may be formed to have an inner diameter larger than that of the axial spline portion 330, so as to prevent damage to the cylindrical press-fit portion 340 caused by the spline coupling portion 240 provided on the wheel hub 200 when the inner ring 300 is mounted to the wheel hub 200.

According to an embodiment of the present disclosure, the vehicle wheel bearing 100 may be configured to comprise sealing members for preventing inflow of external foreign substances.

According to an embodiment of the present disclosure, the vehicle wheel bearing 100 may comprise an outboard-side sealing member 600 configured to perform sealing at an axially outer end portion of a bearing space in which rolling elements 500 are disposed, and an inboard-side sealing member 700 configured to perform sealing at an axially inner end portion of the bearing space in which the rolling elements 500 are disposed, thereby preventing external foreign substances from entering the bearing space in which the rolling elements 500 are located.

According to an embodiment of the present disclosure, the outboard-side sealing member 600 and the inboard-side sealing member 700 may be configured in a manner similar to that of sealing members used in conventional vehicle wheel bearings, and the vehicle wheel bearing 100 according to an embodiment of the present disclosure is not characterized by a specific structure of these sealing members. Accordingly, detailed descriptions thereof will be omitted herein.

According to an embodiment of the present disclosure, the vehicle wheel bearing 100 may further comprise a spline portion sealing member 800 configured to perform sealing around a spline engagement portion at which a face spline portion 310 provided on the vehicle wheel bearing 100 is engaged with a corresponding face spline portion 910 provided on the constant velocity joint 900.

According to an embodiment of the present disclosure, the spline portion sealing member 800 may be configured to be mounted to an outer circumferential surface 350 of the inner ring 300 in a press-fitted manner, and may perform a function of surrounding a spline engagement portion from a radially outer side so as to prevent inflow of external foreign substances to the spline engagement portion.

According to an embodiment of the present disclosure, an inboard-side sealing member 700 configured to seal an axially inner end portion of the wheel bearing 100 may be configured to be mounted to the spline portion sealing member 800 in a press-fitted manner.

The vehicle wheel bearing 100 according to an embodiment of the present disclosure is configured such that the inboard-side sealing member 700 is press-fitted and mounted to the spline portion sealing member 800 as described above. Accordingly, the inboard-side sealing member 700 and the spline portion sealing member 800 can be stably mounted together on the inner ring 300 without the need to provide a plurality of mounting portions on the inner ring 300.

According to an embodiment of the present disclosure, the spline portion sealing member 800 may be configured to comprise a frame 810 forming a basic body, and an elastic sealing portion 820 attached to the frame 810.

According to an embodiment of the present disclosure, a frame 810 of the spline portion sealing member 800 may be formed of a bent metal plate, and may have an overall generally cylindrical shape so as to be press-fitted and coupled to an outer circumferential surface 350 of the inner ring 300.

According to an embodiment of the present disclosure, an elastic sealing portion 820 of the spline portion sealing member 800 may be integrally attached to one side of the frame 810, and the elastic sealing portion 820 may be provided with at least one sealing lip 822, wherein the sealing lip 822 may be configured to contact one side of the constant velocity joint 900 to perform sealing.

According to an embodiment of the present disclosure, the frame 810 of the spline portion sealing member 800 may be formed to have a stepped structure in which an axially inner portion has a smaller diameter than an axially outer portion.

For example, the frame 810 of the spline portion sealing member 800 may be configured to comprise a press-fit portion 812 on which the inboard-side sealing member 700 is mounted, and a diameter-reduced portion 814 located at an axially inner side of the press-fit portion 812. Accordingly, when the inboard-side sealing member 700 is press-fitted and mounted to the spline portion sealing member 800, interference at the axially inner portion of the frame 810 can be prevented.

According to an embodiment of the present disclosure, an elastic sealing portion 820 of the spline portion sealing member 800 may be configured to be provided only in a region excluding a press-fit portion 812 of the frame 810. For example, as shown in the drawings, the elastic sealing portion 820 of the spline portion sealing member 800 may be configured to be provided only in a diameter-reduced portion 814 of the frame 810.

According to an embodiment of the present disclosure, the elastic sealing portion 820 may be configured such that an outer circumferential surface thereof has a smaller diameter than an outer circumferential surface of the press-fit portion 812 of the frame 810. Accordingly, when the inboard-side sealing member 700 is press-fitted and mounted to the spline portion sealing member 800, interference caused by the elastic sealing portion 820 can be prevented.

According to an embodiment of the present disclosure, the frame 810 of the spline portion sealing member 800 may be configured to comprise a bent portion 816, which is radially bent, at an axially outer end portion thereof.

According to an embodiment of the present disclosure, the bent portion 816 may be configured to contact the inboard-side sealing member 700 when the inboard-side sealing member 700 is press-fitted and mounted to the spline portion sealing member 800, thereby preventing movement of the inboard-side sealing member 700. In addition, the bent portion 816 may be configured to contact a stopper portion 370, which will be described later, thereby preventing movement of the spline portion sealing member 800.

According to an embodiment of the present disclosure, an axially extending extension portion 360 may be provided at an axially inner end portion of the inner ring 300, and a face spline portion 310 may be formed on an axial end face of the extension portion 360 of the inner ring 300.

According to an embodiment of the present disclosure, the extension portion 360 of the inner ring 300 may be configured to comprise a inclined portion 362 on an outer circumferential surface thereof, the inclined portion 362 having a diameter that decreases as it extends axially inward. The spline portion sealing member 800 may be disposed to be spaced apart from the inclined portion 362.

According to an embodiment of the present disclosure, the inclined portion 362 provided on the outer circumferential surface of the extension portion 360 of the inner ring 300 may be formed as a straight inclined surface as shown in the drawings, or alternatively may be formed as a curved inclined surface.

According to an embodiment of the present disclosure, the inclined portion 362 provided on the outer circumferential surface of the extension portion 360 of the inner ring 300 may be preferably formed to have an inclination angle of 30°or less with respect to an axial direction.

If the inclined portion 362 provided on the outer circumferential surface of the extension portion 360 is formed to have an inclination angle greater than 30°, it may become difficult to form a sufficient surface for forming the face spline portion 330 on the axial end face of the extension portion 360 of the inner ring 300.

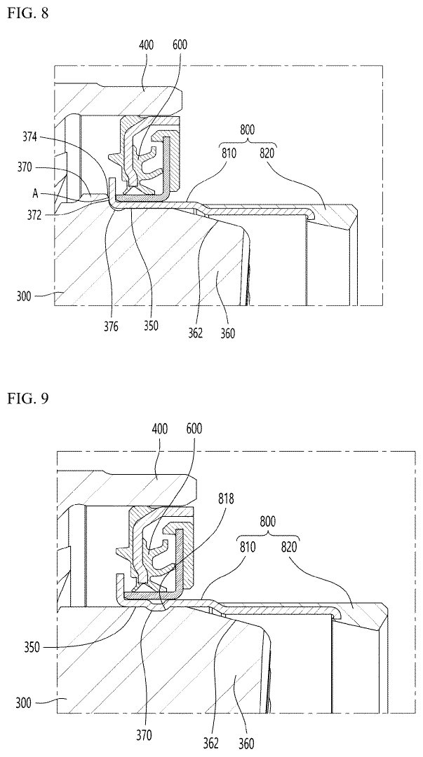

According to an embodiment of the present disclosure, a stopper portion 370 may be provided on an outer circumferential surface 350 of the inner ring 300, and movement of the spline portion sealing member 800 may be prevented by the stopper portion 370. According to an embodiment of the present disclosure, the stopper portion 370 may be formed as a protrusion protruding radially outward from the outer circumferential surface 350 of the inner ring 300, such that one side of the spline portion sealing member 800 is caught by the protrusion-shaped stopper portion 370, thereby preventing movement thereof (see FIG. 8).

According to an embodiment of the present disclosure, the protrusion-shaped stopper portion 370 may be configured such that a radially outer end A of an axial contact end face 372, which contacts the spline portion sealing member 800, is positioned radially outward relative to an outer circumferential surface of the press-fit portion 812 of the spline portion sealing member 800, thereby ensuring stable engagement and support with respect to the spline portion sealing member 800.

According to an embodiment of the present disclosure, the protrusion-shaped stopper portion 370 may be formed such that an axial length from an axially outer end of the inclined portion 362 to an axial contact end face 372 of the stopper portion 370 is greater than an axial length from the axial contact end face 372 of the stopper portion 370 to an axially inner end of axially inner rolling elements 500 (inboard-side rolling elements) so as to ensure a sufficient press-fit surface for mounting the spline portion sealing member 800.

According to an embodiment of the present disclosure, a radially outer portion of the axial contact end face 372 of the stopper portion 370 may be provided with an outer edge portion 374 having a chamfered or rounded structure. In addition, a radially inner edge portion of the axial contact end face 372 of the stopper portion 370 (i.e., an edge portion between the axial contact end face 372 of the stopper portion 370 and the outer circumferential surface 350 of the inner ring 300) may be provided with a recessed undercut 376. Accordingly, a grinding process for forming the press-fit surface can be facilitated, and stable mounting of the spline portion sealing member 800 can be achieved. According to an embodiment of the present disclosure, the stopper portion 370 is not limited to the protrusion-shaped structure described above, and may be modified into various other structures capable of preventing movement of the spline portion sealing member 800.

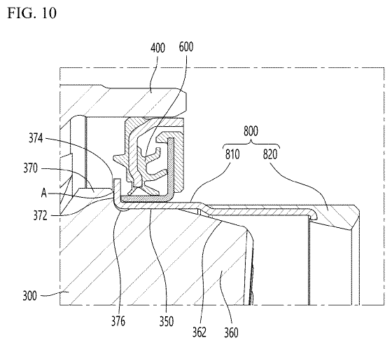

Referring to FIGS. 9 and 10, modified examples of the stopper portion 370 are illustratively shown.

For example, according to an embodiment of the present disclosure, the stopper portion 370 may be formed as a recessed structure recessed radially inward from an outer circumferential surface 350 of the inner ring 300, as shown in FIG. 9, such that one side of the spline portion sealing member 800 is caught by the recessed stopper portion 370 to prevent movement thereof.

According to the embodiment illustrated in FIG. 9, a frame 810 of the spline portion sealing member 800 may be provided with a protruding portion 818 protruding radially inward from an inner circumferential surface thereof, and the protruding portion 818 may be caught by the recessed stopper portion 370 to prevent movement of the spline portion sealing member 800.

According to an embodiment of the present disclosure, the recessed stopper portion 370 may be configured such that an axial length from an axially outer end of the inclined portion 362 to a center of the recess of the stopper portion 370 is smaller than an axial length from the center of the recess of the stopper portion 370 to an axially inner end of axially inner rolling elements 500 (inboard-side rolling elements).

If the recessed stopper portion 370 is formed such that an axial length from an axially outer end of the inclined portion 362 to a center of the recess of the stopper portion 370 is greater than an axial length from the center of the recess of the stopper portion 370 to an axially inner end of axially inner rolling elements 500 (inboard-side rolling elements), an axial length of the spline portion sealing member 800 may be significantly increased, which may cause an increase in manufacturing cost.

Meanwhile, according to an embodiment of the present disclosure, the stopper portion 370 may be formed as a stepped structure, as shown in FIG. 10, such that one side of the spline portion sealing member 800 is caught by the stepped stopper portion 370 to prevent movement thereof.

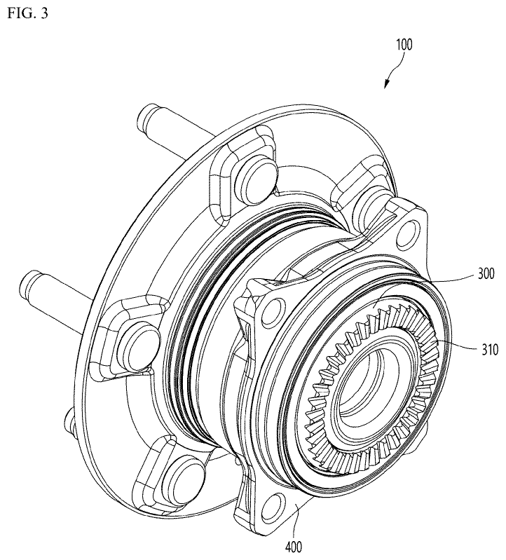

In this case, the stepped stopper portion 370 may be configured, similarly to the embodiments shown in FIGS. 3 to 8, such that an axial length from an axially outer end of the inclined portion 362 to an axial contact end face 372 of the stopper portion 370 is greater than an axial length from the axial contact end face 372 of the stopper portion 370 to an axially inner end of axially inner rolling elements 500 (inboard-side rolling elements).

As such, the vehicle wheel bearing 100 according to an embodiment of the present disclosure may be provided with the stopper portion 370 on the outer circumferential surface 350 of the inner ring 300 on which the spline portion sealing member 800 is mounted. Accordingly, when the inboard-side sealing member 700 is press-fitted and mounted to the spline portion sealing member 800, movement of the spline portion sealing member 800 caused by press-fitting force can be prevented.

Although the present disclosure has been described above with reference to specific matters such as particular constituent elements and limited embodiments, these embodiments are provided only to assist in a more comprehensive understanding of the present disclosure, and the present disclosure is not limited thereto. Rather, various modifications and variations may be made from such descriptions by a person having ordinary skill in the art to which the present disclosure pertains.

Accordingly, the spirit of the present disclosure should not be construed as being limited to the embodiments described above, and not only the claims set forth below but also all modifications and variations that are equivalent or substantially equivalent to the scope of the claims should be understood as falling within the scope of the spirit of the present disclosure.

1. A vehicle wheel bearing (100) for rotatably mounting and supporting a vehicle wheel to a vehicle body, comprising:
a wheel hub (200) to which a vehicle wheel is mounted and which rotates together with the vehicle wheel;
at least one inner ring (300) mounted to the wheel hub (200);
an outer ring (400) fixedly coupled to a vehicle-body-side member;
a plurality of rolling elements (500) configured to rotatably support the wheel hub (200) and the inner rings (300) relative to the outer ring (400); and
a sealing member configured to prevent inflow of foreign substances,
wherein an axially inner end surface of the wheel hub (200) or the inner ring (300) is provided with a face spline portion (310), and the face spline portion (310) is configured to engage with corresponding face spline portion (910) formed on a constant velocity joint (900) to transmit driving power,
wherein the sealing member comprises: an outboard-side sealing member (600) configured to perform sealing at an axially outer end portion of a bearing space in which the rolling elements (500) are located; an inboard-side sealing member (700) configured to perform sealing at an axially inner end portion of the bearing space; and a spline portion sealing member (800) configured to perform sealing around the face spline portion (310),
wherein the spline portion sealing member (800) is configured to be mounted to an outer circumferential surface (350) of the inner ring (300) in a press-fitted manner, and
wherein a stopper portion (370) is provided on the outer circumferential surface (350) of the inner ring (300) so that movement of the spline portion sealing member (800) is prevented by the stopper portion (370).

2. The vehicle wheel bearing according to claim 1, wherein the inboard-side sealing member (700) is configured to be mounted to the spline portion sealing member (800) in a press-fitted manner.

3. The vehicle wheel bearing according to claim 2, wherein an axially inner end portion of the inner ring (300) comprises an extension portion (360) extending axially inward, and
wherein an outer circumferential surface of the extension portion (360) is provided with an inclined portion (362) having a diameter that decreases as it extends axially inward.

4. The vehicle wheel bearing according to claim 3, wherein the spline portion sealing member (800) is disposed to be spaced apart from the inclined portion (362).

5. The vehicle wheel bearing according to claim 4, wherein the inclined portion (362) is formed as an inclined surface having an inclination angle of 30° or less with respect to an axial direction.

6. The vehicle wheel bearing according to claim 2, wherein the spline portion sealing member (800) comprises a frame (810) and an elastic sealing portion (820) attached to the frame (810), and
wherein the spline portion sealing member (800) is configured such that the frame (810) is mounted to the outer circumferential surface (350) of the inner ring (300) in a press-fitted manner.

7. The vehicle wheel bearing according to claim 6, wherein the frame (810) of the spline portion sealing member (800) comprises: a press-fitting portion (812) on which the inboard-side sealing member (700) is mounted; and a diameter-reduced portion (814) positioned axially inward of the press-fitting portion (812).

8. The vehicle wheel bearing according to claim 7, wherein the elastic sealing portion (820) of the spline portion sealing member (800) is formed to the diameter-reduced portion (814) of the frame (810), and
wherein an outer circumferential surface of the elastic sealing portion (820) of the spline portion sealing member (800) is formed to have a diameter smaller than an outer circumferential surface of the press-fitting portion (812) of the frame (810).

9. The vehicle wheel bearing according to claim 8, wherein the frame (810) of the spline portion sealing member (800) comprises a bent portion (816) bent in a radial direction at an axially outer end portion thereof.

10. The vehicle wheel bearing according to claim 9, wherein the elastic sealing portion (820) of the spline portion sealing member (800) comprises at least one sealing lip (822), and
wherein the sealing lip (822) is configured to contact a portion of the constant velocity joint (900) to perform sealing.

11. The vehicle wheel bearing according to claim 1, wherein the stopper portion (370) is formed as a protrusion or a stepped shape protruding radially outward from the outer circumferential surface (350) of the inner ring (300), such that one side of the spline portion sealing member (800) is caught by the protrusion or stepped-shaped stopper portion (370) to prevent movement thereof.

12. The vehicle wheel bearing according to claim 11, wherein a radially outer end A of an axial contact end surface (372) of the stopper portion (370) that contacts the spline portion sealing member (800) is positioned radially outward relative to an outer circumferential surface of the press-fitting portion (812) of the frame (810) of the spline portion sealing member (800).

13. The vehicle wheel bearing according to claim 12, wherein an axial length from an axially outer end of the inclined portion (362) to the axial contact end surface (372) of the stopper portion (370) is formed to be greater than an axial length from the axial contact end surface (372) of the stopper portion (370) to an axially inner end of axially inner rolling elements (500).

14. The vehicle wheel bearing according to claim 1, wherein the stopper portion (370) is formed as a recessed structure recessed radially inward from the outer circumferential surface (350) of the inner ring (300), such that one side of the spline portion sealing member (800) is caught by the recessed stopper portion (370) to prevent movement thereof.

15. The vehicle wheel bearing according to claim 14, wherein an axial length from an axially outer end of the inclined portion (362) to a center of the recessed stopper portion (370) is formed to be smaller than an axial length from the center of the recessed stopper portion (370) to an axially inner end of axially inner rolling elements (500).
